(19) United States
(12) Patent Application Publication
(10) Pub. No.: US 2026/0217526 A1
(43) Pub. Date: Jul. 30, 2026

(54) A METHOD AND A SYSTEM FOR CARBON NEUTRAL POWER GENERATION

(71) Applicant: NUOVO PIGNONE TECNOLOGIE - S.R.L., Florence (IT)

(72) Inventors: Maneesh PANDEY, Bangalore, Bangalore Kamataka (IN); Manjush GANIGER, Bangalore, Bangalore Kamataka (IN)

(21) Appl. No.: 19/142,851

(22) PCT Filed: Dec. 20, 2023
(86) PCT No.: PCT/EP2023/025550

§ 371 Date: Jun. 24, 2025

(30) Foreign Application Priority Data
Dec. 29, 2022 (IT) 102022000027156

(51) Int. Cl. C01B 3/38; B01D 53/047; C01B 3/382; C01B 3/56; F01D 15/10; F01K 7/16

(52) U.S. Cl. CPC C01B 3/38; B01D 53/047; C01B 3/382; C01B 3/56; F01D 15/10; F01K 7/16; B01D 2256/16; B01D 2257/504; C01B 2203/0233; C01B 2203/042; C01B 2203/0475; C01B 2203/0822; C01B 2203/0833; C01B 2203/1241; C01B 2203/84; F05D 2220/64

(57) ABSTRACT

A method and a system for carbon neutral power generation integrating generating power by means of a gas turbine using hydrogen as fuel. Hydrogen is produced by a modular natural gas steam reforming unit. Carbon capture and heat recovery from the turbine exhaust gases to heat the natural gas and the steam fed to the steam reforming step are also provided.

### TECHNICAL FIELD

The present disclosure concerns a method for carbon neutral power generation and a related system for carbon neutral power generation based on the conversion of existing natural gas pipeline installations producing power using natural gas, by means of producing hydrogen locally and CO₂ capture using pre-combustion technologies and gas turbine to burn H₂ as fuel and air as oxidizer.

Embodiments disclosed herein specifically concern methods and systems for carbon neutral power generation comprising

### Background Art

Gas turbines are commonly used to generate power at power stations by combusting fuel therein. In particular, the basic operation of a gas turbine is a Brayton cycle with air as the working fluid: atmospheric air flows through a compressor that brings it to a higher pressure; energy is then added by spraying fuel into the air in a combustion chamber and igniting it so that a combustion generates a high-temperature flow; this high-temperature pressurized gas enters a turbine, producing a shaft work output in the process, used to drive the compressor; the unused energy comes out in the exhaust gases that can be repurposed for external work, such as directly producing thrust in a turbojet engine, or rotating a second, independent turbine (known as a power turbine) that can be connected to a fan, propeller, or electrical generator. The purpose of the gas turbine determines the design so that the most desirable split of energy between the thrust and the shaft work is achieved. The fourth step of the Brayton cycle (cooling of the working fluid) is omitted, as gas turbines are open systems that do not reuse the same air.

Commonly used fuels includes natural gas, propane, diesel, biogas and bio-diesel. One of the main problems associated with combusting fuels such as these in gas turbines is the resultant production of carbon dioxide (CO₂) gas. Increased CO₂ levels in the atmosphere are detrimental to the environment and are a known cause of global warming. As such, there is a need to prevent gas turbine produced CO₂ from entering the atmosphere, i.e. to decarbonize gas turbine power generation.

Currently, there are two ways to decarbonize gas turbine power generation:
using a carbon capture unit to capture CO₂ from exhaust gases of a gas turbine;
operating the gas turbine fluid switching from natural gas to hydrogen or blended fuel.

However, both technologies are affected by important limitations. In fact, exhaust gases of a gas turbine are composed of a very small amount of CO₂, namely only 3 mol %. Because of this, the size of the carbon capture unit required is huge and it is very expensive. On the other hand, operating gas turbines with hydrogen as fuel, instead of natural gas, importantly reduces the carbon footprint, but in order to feed the gas turbine with hydrogen establishing a hydrogen infrastructure is needed, including pipelines, storage & transformation plants specifically designed for hydrogen.

Steam reforming is currently the most cost-effective technology to produce hydrogen, particularly in case natural gas or off gases can be used as feedstock. Steam reforming of natural gas is the workhorse for such production being a quite efficient process, with the highest H₂/CO ratio and the lowest Cost of Production (CoP). However, such process is not exempt from CO₂ emissions.

In hydrogen production through steam reforming process, a part of CO₂ (typically~50-60% of the total amount) is generated inside the process syngas in the steam reforming (CH₄+H₂O=CO+3H2) and water gas shift (CO+H₂O=CO₂+H₂) reactors and downstream stages, while another part (40-50%) is additionally generated in the steam reformer furnace where heat provided by external fuel combustion sup-plies the necessary thermal input to the endothermic reaction. It is estimated that around 0.9 kg CO₂ are produced per Nm³ of H₂.

In particular, according to the prior art, the process architecture of a conventional hydrogen production unit with steam reforming of natural gas feedstock includes the following conventional process steps:
i. natural gas compression and preheating,
ii. pretreating to remove detrimental compounds,
iii. reacting the compressed natural gas with steam to obtain hydrogen and carbon monoxide, together with residual steam,
iv. heat recovery from both process stream and flue gas by steam generation and steam superheating,
v. reacting the carbon monoxide with steam to obtain hydrogen and carbon dioxide (water shift reaction),
vi. purification of the hydrogen stream by pressure swing adsorption.

Making reference to FIG. 1, a block diagram of a conventional natural gas hydrogen production unit is shown, wherein a natural gas stream 10 is fed under pressure to a pre-treatment unit (not shown) for the removal of those compounds that are detrimental for a steam reforming catalyst downstream.

The treated natural gas stream 10 is then mixed with a controlled quantity of steam 11 according to a selected value for the steam/carbon molar ratio (S/C=3 mol/mol, typical value) and preheated at 550° C. (typical value). The heart of the process is an endothermic reaction of methane with steam over a Ni catalyst, as follows:

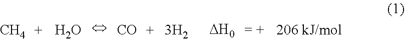

The reaction (1) is conducted in a tubular catalytic reactor 12 heated up by combustion of an external fuel stream 13 in a furnace (not shown). In series to the main methane reaction, the water gas shift reaction converts part of the CO produced by the first reaction into additional H₂ and CO₂, as follows:

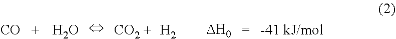

The process steam added to the feed is in excess of the stoichiometric quantity so as to improve the hydrocarbons conversion and prevent any carbon deposition over the catalyst. Reforming temperatures are selected in a high range (typically 850÷920° C.) in order to obtain high hydrogen yields. The operation of steam reforming causes an excess heat Q generation, which is normally recovered in a heat exchanger 14 through generation of high pressure steam, which can be used in part as the steam feed stream 11. Besides this, additional steam is generated by a process gas heat exchanger (not shown) employed to cool down the process syngas 15 at the outlet of the reactor 12.

The cooled process gas is then fed to a high temperature shift conversion stage at an inlet temperature of about 320° C. The shift reactor 16 is a fixed bed adiabatic reactor using an iron/chromium/copper oxide catalyst which converts the carbon monoxide and steam present in the syngas into additional hydrogen and carbon dioxide according to the water gas shift reaction (reaction 2). In some cases, an additional stage of shift conversion at lower temperature (not shown) is installed downstream and operated.

The process syngas stream 17 at the outlet of the shift conversion reactor 16 is cooled down to about 40° C. through a heat recovery section and a final cooler (not shown). Downstream, an equipment (not shown) for water condensate removal is installed, from which the syngas stream 17 is sent to a pressure swing adsorption unit 18 to perform the raw hydrogen purification. The pressure swing adsorption unit 18 operates through short adsorption/desorption cycles conducted over selected adsorbent materials and operated in parallel vessels at different time stages.

A hydrogen stream 19 is released from the pressure swing adsorption unit 18 at a set pressure (typically about 20 barg for refinery applications, for example). The hydrogen recovery factor of the pressure swing adsorption unit 18 can achieve values up to 90%, while the hydrogen balance, together with the impurities present in the raw hydrogen stream, is released in an off-gas stream 20 and leaves the pressure swing adsorption unit 18 at low pressure (~0.3 barg). The pressure swing adsorption unit 18 can reach hydrogen purity up to 99.9999% vol. Typical hydrogen purity specification in refinery is >99.9%.

The off-gas stream 20 from the pressure swing adsorption unit 18 recovered at near atmospheric pressure and containing the produced CO₂ and residual hydrogen (an exemplary composition of this stream being CH₄ 18% mol, CO 10.24% mol, CO₂ 45.10% mol, H₂ 26% mol, H₂O 0.55% mol) is recycled back (recycle stream, not shown) to the reformer furnace (not shown), where residual hydrogen and CO are burned with make-up fuel 13 and the generated flue gas is sent to the stack.

It is also known that carbon capture and storage (CCS) is the process of removing or reducing the CO₂ content of streams normally released to the atmosphere and transporting captured CO₂ to a location for permanent storage. CCS can be applied to a wide range of large single-point sources, such as process streams, heater and boiler exhausts, and vents from a range of high CO₂ footprint industries, including power generation, refining, natural gas treating, chemicals, cement production and steel production. There are three main CO₂ capture systems associated with different combustion processes, namely, post-combustion, pre-combustion and oxyfuel combustion.

In post-combustion capture processes the removal of CO₂ is performed after combustion has taken place. The flue gases exiting combustion plants are typically treated using chemical or physical sorbents to selectively remove CO₂ from the gas mixture. It is an end-of-pipe solution, where CO₂ is removed from the flue gas before the flue gas is emitted to atmosphere via the stack. The advantage of the post-combustion process is that it is suited not only to new installations but may also be retrofitted to existing plants. The main challenge is that the CO₂ level in combustion flue gas is normally quite low, from 5% vol to 20% vol depending on off-gas content in mixed fuel gas.

In pre-combustion capture processes the fuel (normally coal or natural gas) is pretreated before combustion. In particular, it is generally gasified or reformed to a syngas stream, which is then subject to water-gas shift reaction and subsequent gas clean up to separate the produced hydrogen from CO₂. The gas cleaning step is usually achieved using similar methods employed as described for post-combustion processes, although there are advantages to removing CO₂ from the syngas mainly associated with the pressure of the gas which reduces compression energy requirements. Hydrogen is used as the input fuel to the combustion process, whilst CO₂ is available in a concentrated form for compression, transport and storage. The high concentration (>20%) of CO₂ in the H₂/CO₂ fuel gas mixture facilitates the CO₂ separation.

In oxyfuel combustion, oxygen, instead of air, is used for combustion. This reduces the amount of nitrogen present in the exhaust gas that affects the subsequent separation process. The major components of the flue gases are CO₂, water, particulates and SO₂. After the removal of particulates, SO₂ and water, the remaining gases contain a high concentration of CO₂, about 80-98% (depending on the fuel used).

Both pre combustion and post combustion technologies for CO₂ capture can be applied to a hydrogen production plant by steam reforming of natural gas. The pre combustion technologies would apply to the syngas stream exiting water gas shift reactors, whereas the post combustion technologies would apply to flue gas from furnace.

In the first case, only the CO₂ coming from the process would be captured. In the second case all CO₂ can be captured, however the cost of such option would be higher taking into consideration the low CO₂ partial pressure in the flue gas, when compared to CO₂ partial pressure in the syngas. Additionally, since the flue gas is available at about atmospheric pressure, large size CO₂ capture systems would be needed, making the cost of such option still higher.

Accordingly, an improved system and method for power generation to address the issues of the release of CO₂ in the atmosphere of the systems of the current art would be beneficial and would be welcomed in the technology. More in general, it would be desirable to provide methods and systems adapted to more efficiently address problems entailed by current methods and systems for power generation using natural gas.

### SUMMARY

In one aspect, the subject matter disclosed herein is directed to a method for carbon neutral power generation, the method comprising the following steps:
producing hydrogen by steam reforming of natural gas from a natural gas pipeline to obtain hydrogen and tail gases;
combusting hydrogen from the hydrogen production step together with air in a gas turbine coupled with an electric generator, to produce electric energy and a hot hydrogen combustion exhaust gas;
capturing a CO₂ fraction from the tail gases from said hydrogen production step, to obtain CO₂ free tail gases;
exchanging heat of the hot exhaust gas from the hydrogen combustion step with the natural gas to be used in said hydrogen production step by steam reforming, to obtain hot natural gas and a residual hot exhaust gas;
exchanging heat of the residual hot exhaust gas from the preceding step with water and/or steam to be used in said hydrogen production step by steam reforming, to obtain hot compressed steam and a residual exhaust gas.

The method can comprise a step of providing heat to said hydrogen production step by combusting the CO₂ free tail gases, from the CO₂ fraction capturing step, together with air, with production of flue gases. The method can also comprise, alternatively:
a step of compressing and recirculating the flue gases from the step of combusting the CO₂ free tail gases to said step of hydrogen production, or
a step of capturing a CO₂ fraction from the flue gases from the step of combusting the CO₂ free tail gases.

In one aspect, natural gas used to produce hydrogen by steam reforming is withdrawn from a natural gas pipeline, its pressure being preliminarily reduced down to 8-10 bar and its temperature being increased up to 300-350° C. Since natural gas from a natural gas pipeline is already treated upstream the pipeline to comply with the pipeline specifications, therefore using the natural gas from a natural gas pipeline has the advantage that pre-treatment of the feed is not needed. Additionally, the pressure of natural gas from a natural gas pipeline being higher than needed to feed a hydrogen production process by steam reforming allows for the possibility to exploit higher pressure to provide additional power.

A further aspect of the present disclosure is drawn to a system for carbon neutral power generation comprising:
a natural gas feed line, connected to a natural gas pipeline;
a steam feed line;
a hydrogen production unit by steam reforming of natural gas to obtain hydrogen and tail gases;
a gas turbine connected upstream to the hydrogen outlet of the hydrogen production unit, the gas turbine being configured to combust hydrogen together with air to obtain an exhaust gas, the gas turbine being coupled with an electric generator to produce electric energy;
a first heat exchanger, configured to heat the feed of natural gas upstream the hydrogen production unit by exchanging heat with the exhaust gas from the gas turbine;
a second heat exchanger configured to heat a stream of water or steam flowing inside the steam feed line upstream the hydrogen production unit by exchanging heat with the exhaust gas from the gas turbine downstream the first heat exchanger;
a carbon capture unit connected upstream to the tail gases outlet of the hydrogen production unit.

Additionally, the system for carbon neutral power generation can comprise a furnace to combust the tail gases downstream the carbon capture unit and provide heat to the hydrogen production unit.

Alternatively, the system for carbon neutral power generation can comprise a carbon capture unit, to remove CO₂ from the exhaust gas from the furnace; or a compressor, to compress the exhaust gas from the furnace before it is recirculated to the hydrogen production unit.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a block diagram of a steam reforming system, according to the prior art;

FIG. 2 illustrates a schematic of a system for carbon neutral power generation, according to a first embodiment;

FIG. 3 illustrates a schematic of a system for carbon neutral power generation, according to a second embodiment;

FIG. 4 illustrates a schematic of a system for carbon neutral power generation, according to a third embodiment;

FIG. 5 illustrates a schematic of a system for carbon neutral power generation, according to a fourth embodiment; and

FIG. 6 illustrates a flow chart of a method for carbon neutral power generation, according to a first embodiment.

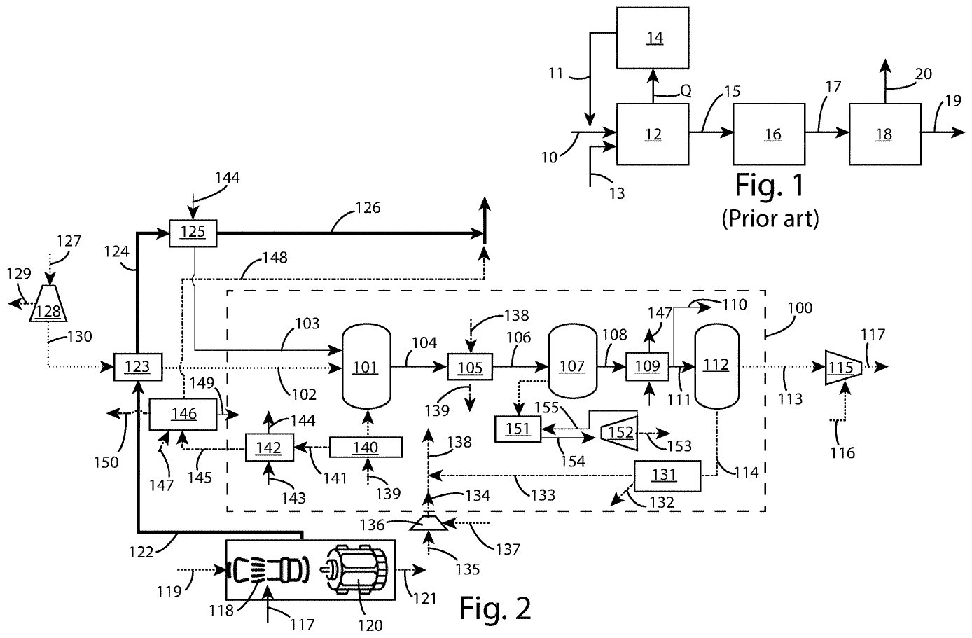

### DETAILED DESCRIPTION OF EMBODIMENTS

According to one aspect, the present subject matter is directed to methods and systems for carbon neutral power generation. Specifically, in several embodiments disclosed herein a system for carbon neutral power generation is provided, which includes integrating a gas turbine with a modular natural gas steam reforming unit, which produces hydrogen to be used as the feed of the gas turbine. The system for carbon neutral power generation additionally comprises at least one carbon capture unit to remove CO₂ from the tail gases of the hydrogen production unit. Additionally, after removal of CO₂, the tail gases of the hydrogen production unit are combusted with air in a furnace, to produce heat and an exhaust gas. A carbon capture unit is provided to remove CO₂ from the exhaust gas of the furnace. Both carbon capture units operate under favorable conditions, because CO₂ content in the tail gases of the hydrogen production unit is high (40-45 mol %) and CO₂ content in the exhaust gas of the furnace is also relatively high (15-35 mol %). As a consequence, the size and the cost of carbon capture units are lower than carbon capture units for hydrogen production units by steam reforming according to the current art. To meet the energy requirements of the natural gas steam reforming unit of the hydrogen production unit, the turbine exhaust gases are used to heat the natural gas and the steam fed to the steam reforming unit.

According to one aspect, the hydrogen production step of the method for carbon neutral power generation includes the following sub-steps:
reacting hot natural gas together with hot compressed steam on a catalyst, by providing heat, to obtain a first gas mixture comprising hydrogen and carbon monoxide together with residual natural gas and steam;
reacting carbon monoxide and steam of the first gas mixture to obtain a second gas mixture comprising a higher concentration of hydrogen together with carbon dioxide and residual natural gas, steam and carbon monoxide; i.e. water gas shifting;
separating hydrogen from the remaining components of the second gas mixture, by adsorbing the remaining components of the second gas mixture from the water gas shifting step on an adsorbent material, and periodically desorbing the adsorbed remaining components of the second gas mixture by dropping the pressure to produce tail gases, i.e. hydrogen pressure swing adsorbing.

According to another aspect, the system for carbon neutral power generation comprises a steam reformer, i.e. a reactor connected upstream to a natural gas pipeline and to a steam feed line, the reactor being configured to react hot natural gas together with hot compressed steam on a catalyst, by providing heat, to obtain a first gas mixture of hydrogen and carbon monoxide together with residual natural gas and steam; a a water gas shift reactor, i.e. a reactor connected upstream to a first gas mixture outlet of the steam reformer, the water gas shift reactor being configured to react carbon monoxide and steam from the steam reformer to obtain heat and a second gas mixture with a higher concentration of hydrogen together with carbon dioxide and residual natural gas, steam and carbon monoxide; and a pressure swing adsorber, i.e. a plurality of vessels containing an adsorbent material and being configured to separate hydrogen from the remaining components of the second gas mixture from the water gas shift reactor, by adsorbing the remaining components of the second gas mixture on the adsorbent material, and periodically and alternately desorbing the adsorbed components by dropping the pressure in each vessel to produce tail gases.

According to still another aspect, the method for carbon neutral power generation allows for converting existing natural gas-based gas turbines to hydrogen-based gas turbines.

According to still another aspect, the method for carbon neutral power generation allows for favorable operating condition of the natural gas steam reforming, the temperature being comprised between 350-800° C. and the pressure being around 10 bar. In particular, the temperature of the feed to the hydrogen production step by steam reforming is much lower than the prior art, as a consequence of the relatively low temperature of the flue gas from the hydrogen combustion step in a gas turbine, which is exploited first to exchange heat with the natural gas upstream the hydrogen production step by steam reforming and secondly to exchange heat with water and/or steam upstream the hydrogen production step by steam reforming. The low temperature of the reactants in the hydrogen production step by steam reforming is balanced by the large availability of heat for operating the hydrogen production step by steam reforming, due to large availability of tail gases from the same hydrogen production step.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments the articles “a”, “an”, “the”, and “said” are intended to mean that there are one or more of the elements. The terms “comprising”, “including”, and “having” are intended to be inclusive and mean that there may be additional elements other than the listed elements.

Referring now to the drawings, FIG. 2 shows a schematic of an exemplary system for carbon neutral power generation. The system is comprised of a hydrogen production unit 100, comprising a natural gas steam reformer 101, wherein a natural gas from a natural gas stream feed line 102 is reacted with steam from a steam feed line 103 to form hydrogen and carbon monoxide, i.e. syngas, according to the reaction:

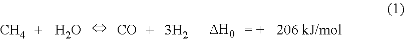

Heat Q′ is provided to the steam reformer 101 to maintain a temperature comprised between the range 350-800° C. The pressure inside the steam reformer 101 is about 10 bar.

The syngas from the steam reformer 101, also comprising unreacted steam, is directed, through a first syngas stream line 104, to a heat exchanger 105, to lower the temperature of the syngas down to 320° C. and subsequently, through a second syngas stream line 106, to a water gas shift conversion reactor 107, wherein, by reacting together with steam part of the CO of the syngas is converted into additional H₂ and CO₂, through the reaction:

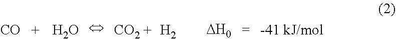

The water gas shift reactor 107 comprises a fixed bed iron/chromium/copper oxide catalyst.

The process syngas at the outlet of the water gas shift conversion reactor 107 is routed, through a third syngas stream line 108 to a heat exchanger 109, wherein it is cooled down to about 40° C. A stream of water condensate is removed from the process syngas stream through the water condensate stream line 110 and the cooled process syngas is then routed through a cooled process syngas stream line 111 to a pressure swing adsorption unit 112 to perform the raw hydrogen purification. In some embodiments, the pressure swing adsorption unit 112 comprises a plurality of vessels, in each vessel being present a bed of a selected adsorbent material, such as zeolites or activated carbons. The pressure swing adsorption unit 112 operates through short adsorption/desorption cycles conducted over selected adsorbent materials and operated in parallel vessels (not shown) at different time stages. In particular, at a first operating pressure, hydrogen of the gas stream from the water gas shift reactor 107 permeates through the adsorbent material, while the remaining components of the gas stream are adsorbed on the adsorbent material. Periodically and alternately each vessel operates at low pressure to promote desorption of the adsorbed gases. A hydrogen stream is released from the pressure swing adsorption unit 112 through a hydrogen stream line 113 at a pressure of about 9 bar. The tail gases from the pressure swing adsorption unit 112 are collected through a tail gas line 114 at a pressure of about 1 bar and a temperature of about 40° C.

Hydrogen from the pressure swing adsorption unit 112 is compressed in a compressor 115, to which power is provided though a power line 116. The compressed hydrogen is routed, through a hydrogen stream line 117, to a gas turbine 118, wherein it is combusted together with air from an air feed line 119. The gas turbine 118 is coupled with an electrical generator 120, to convert the kinetic energy of the gas turbine 118 into power 121.

The flue gas from the gas turbine 118 has a temperature of around 490° C. and is exploited to heat the streams of reactants to hydrogen production unit 100, namely to the steam reformer 101. In particular, the flue gas from the gas turbine 118 is first routed through a first flue gas stream line 122 to a natural gas heat exchanger 123, to heat the natural gas directed to the steam reformer 101 through the natural gas stream line 102 up to a temperature of about 340° C. Downstream the natural gas heat exchanger 123, the flue gas stream is routed through a second flue gas stream line 124 to a water/steam heat exchanger 125, to heat and vaporize the water/steam directed to the steam reformer 101 through the steam stream line 103 up to a temperature of about 340° C. The flue gas stream, at a residual temperature of about 330-335° C. is then released to the atmosphere trough a third flue gas stream line 126.

The natural gas heated inside the natural gas heat exchanger 123 is withdrawn from a natural gas pipeline (not shown) through a natural gas stream line 127. Since the pressure of natural gas from a natural gas pipeline is higher than needed to feed the steam reformer 101, then it is expanded in an expander 128 to provide additional power 129 and subsequently directed to the heat exchanger 123 through an expanded natural gas stream line 130.

The tail gases from the pressure swing adsorption unit 112 are recovered at near atmospheric pressure through the tail gas stream line 114. Since CO₂ content in the tail gases of the pressure swing adsorption unit 112 is high (40-45 mol %) then the tail gases are directed to a carbon capture unit 131 to separate CO₂, which can be recovered through the CO₂ line 132, and a CO₂ free tail gas stream. The carbon capture unit uses a pre-combustion carbon capture technology, such as for example, K₂CO₃ sorbent or a mixed salt process (such as for example mixing K₂CO₃ and (NH₄)₂CO₃). In some embodiments, the carbon capture absorption unit comprises a large packed bed absorber column with circulating chemical solvents, such as for example amine-based solvents, fluidically coupled to a regeneration column. A mixture of gas containing CO₂ enters the bottom section of the absorber column. The solvent, flowing down, selectively captures CO₂ flowing upward through the column, so that CO₂ free gases come out from the top of the absorber column. The solvent rich in CO₂ is circulated to the regeneration column, wherein CO₂ is desorbed from the solvent by providing steam. The lean solvent is then recycled back to the absorber column after heat removal. In some alternative embodiments, a plurality of packed bed absorber columns are used. In some embodiments, other means of disassociation energy are used in place of steam. The CO₂ free tail gas stream is routed through a CO₂ free tail gas stream line 133 to mix with air from an air feed line 134. Air is retrieved from the atmosphere at ambient pressure through a low pressure air line 135 and is compressed by a compressor 136, to which power is provided though a power line 137. The gas mixture composed of tail gases and air is directed, through a first gas mixture line 138, to the heat exchanger 105, to be heated by the syngas from the steam reformer 101 and subsequently, through a second gas mixture line 139, to a furnace 140, where air and tail gases are burned to generate an exhaust gas and heat Q′ to be provided to the steam reformer 101. The exhaust gas from the furnace 140, at a temperature of about 130° C., is routed through a first furnace exhaust gas stream line 141 to a heat exchanger 142, to pre-heat a water stream from a water stream line 143, the water stream comprising recirculated water and make-up water. Pre-heated water is sent to the heat exchanger 125 through a pre-heated water stream line 144 to be further heated and even partly vaporized by exchanging heat with the flue gas stream from the gas turbine 118. Downstream the heat exchanger 142, the exhaust gas from the furnace, having a relatively high CO₂ content (15-35 mol %), is directed through a second furnace exhaust gas stream line 145 to a second carbon capture unit 146, together with a stream of steam at a temperature of 133° C. and a pressure of 3 bar, said steam coming from the heat exchanger 109 through a steam stream line 147.

The carbon capture unit 146 separates water and CO₂ from the furnace exhaust gas stream. The carbon capture unit 146 implements a post-combustion carbon capture technology. In some embodiments, the carbon capture unit 146 comprises a rotating packed bed absorber column. The rotating packed bed contains rotating packed discs, enclosed in a vessel. A concentrated solvent (such as for example amine-based solvents) flows radially from an inner edge towards an outer edge of the rotating packed bed. When the gas mixture consisting mainly of CO₂ flows inside the absorber column, the solvent absorbs CO₂. The CO₂ rich solvent is stripped of CO₂ in a rotating regenerator packed bed by providing heat input for example by passing steam. In some embodiments, a plurality of rotating packed bed absorber columns is used. The water and CO₂ free furnace exhaust gas stream is then routed through an exhaust gas stream line 148, to mix with the gas turbine exhaust gas stream of the exhaust gas stream line 126 and to be subsequently released to the atmosphere.

Water and CO₂ from the carbon capture unit 146 are collected respectively through a water collection line 149 and a CO₂ collection line 150.

In some embodiments, an additional heat exchanger 151 is present, this heat exchanger 151 being configured to transfer heat Q″ from the water gas shift reactor 107 to a water stream in a thermodynamic cycle including a steam turbine 152 configured to produce power 153. In particular, steam from the heat exchanger 151, at a temperature of 250° C. and pressure of 15 bar, is routed to the steam turbine 152 through a high pressure line 154 and the stream at the outlet of the steam turbine 152 is returned to the heat exchanger 151 through a low pressure line 155.

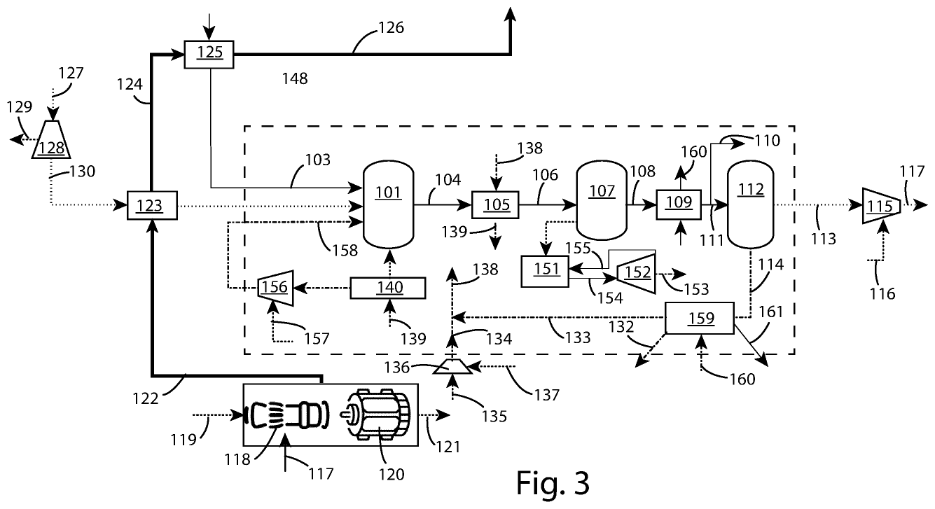

With continuing reference to FIG. 2, FIG. 3 illustrates a second embodiment of a system for carbon neutral power generation. The same reference numbers designate the same or corresponding parts, elements or components already illustrated in FIG. 2 and described above, and which will not be described again.

According to this embodiment, the exhaust gas from the furnace 140 is not released to the atmosphere, rather it is recirculated to the hydrogen production unit 101. In particular, a compressor 156 is connected upstream to an exhaust gas outlet of the furnace 140 through an exhaust gas stream line 141 and is connected downstream to the hydrogen production unit 100 through a compressor outlet line 158. The tail gases of the pressure swing adsorption unit 112 are directed to a carbon capture unit 159 to separate CO₂, the carbon capture unit 159 being additionally connected upstream to the stream of steam at a temperature of 133° C. and a pressure of 3 bar coming from the heat exchanger 109 through a steam stream line 160. CO₂ is collected from the carbon capture unit 159 through the CO₂ line 132, and water is collected from the carbon capture unit 159 through a water stream line 161.

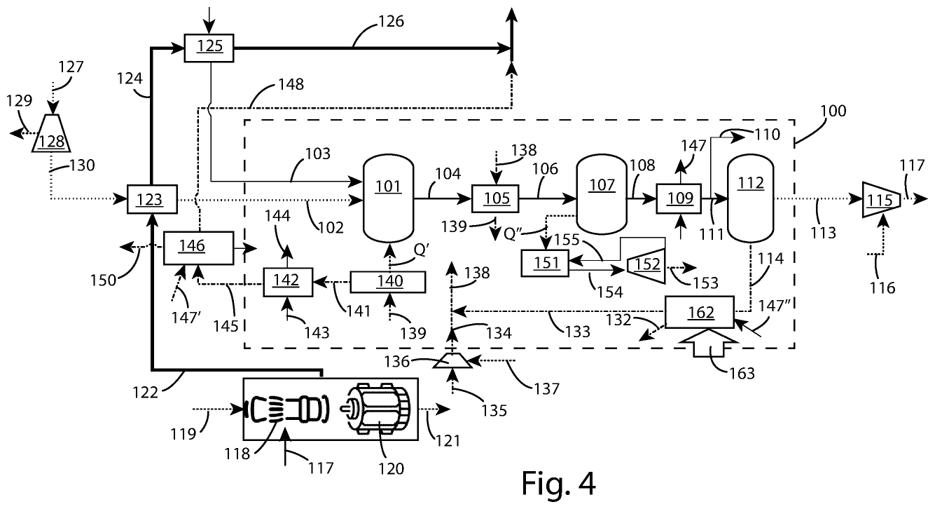

With continuing reference to FIGS. 2 and 3, a further embodiment of a system for carbon neutral power generation is shown in FIG. 4. The same reference numbers designate the same or corresponding parts, elements or components already illustrated in FIGS. 2 and 3 described above, and which will not be described again. The system is different from the system shown in FIG. 2 in that sorbent technology is used in the carbon capture unit 162. In some embodiments, the carbon capture unit 162 comprises a packed bed vertical vessel filled with sorbent material, such as for example mesoporous silicas or zeolites. The mixture of gases containing CO₂ enters the vessel at the bottom flowing upwards, sorbent selectively adsorbs CO₂ from a mixture of gases, leaving the other gas to exit from the top. After a certain time, the gas mixture is sent through a second vessel, while the first bed is regenerated by heating to desorb CO₂ that exits the bed. In some embodiments, a fluidized bed of sorbent material is used. In some embodiments, a plurality of vessels arranged in parallel is used. In some embodiments, lowering pressure is used to desorb CO₂ from the bed. Hot potassium carbonate is fed to the carbon capture unit 162. The sorbent technology reduces steam requirement for carbon capture. As a consequence, the steam coming from the heat exchanger 109 through the steam stream line 147 can be split to be directed respectively to the carbon capture unit 146 through the steam sub-stream line 147′ and to the carbon capture unit 162 through the steam sub-stream line 147″.

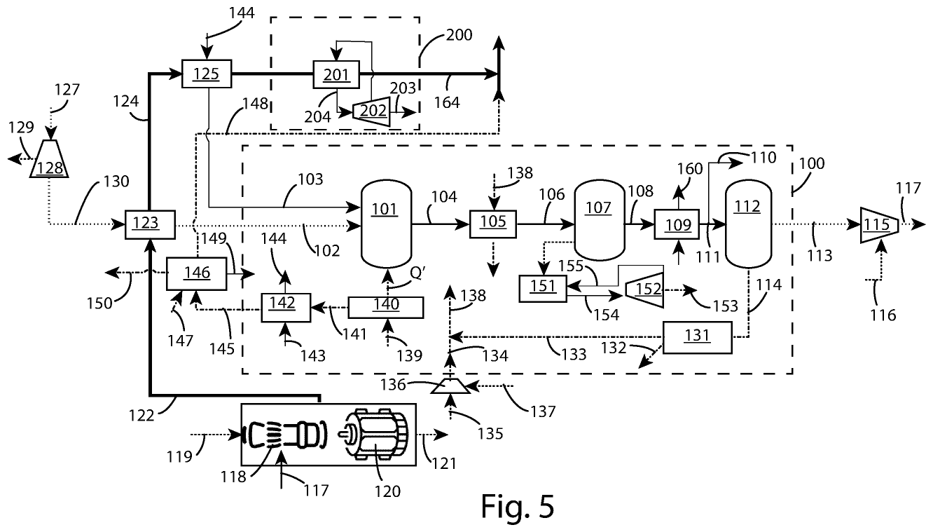

With continuing reference to FIGS. 2, 3 and 4, FIG. 5 illustrates a further embodiment of a system for carbon neutral power generation. The same reference numbers designate the same or corresponding parts, elements or components already illustrated in FIGS. 2, 3 and 4 described above, and which will not be described again. This embodiment is conceived to recover the residual heat of the flue gas from the gas turbine 118, downstream the heat exchangers 123 and 125, by producing additional power. In particular, a thermodynamic system 200 is connected upstream to a flue gas outlet of the second heat exchanger 125 through the flue gas stream line 126. The thermodynamic system 200 comprises a heat exchanger 201 connected upstream to the flue gas stream line 126 and configured to transfer residual heat of the flue gas to a working fluid in a thermodynamic cycle configured to produce additional power. In particular, the working fluid can be water and the thermodynamic cycle is a steam Rankine cycle. The heat exchanger 201 heats and vaporize water to steam at a temperature of 330° C. and a pressure of 15 bar. The steam is routed to a steam turbine 202, configured to produce power 203, through a high pressure steam line 204. The water stream at the outlet of the steam turbine 202 is returned to the heat exchanger 201 through a low pressure water line 205.

The various arrangements illustrated in FIGS. 2 to 5 can be variously combined to one another. For instance, the thermodynamic system 200 conceived to recover the residual heat of the flue gas from the gas turbine 118, downstream the heat exchangers 123 and 125, by producing additional power, can be provided also in the embodiment of FIGS. 2, 3 and 4.

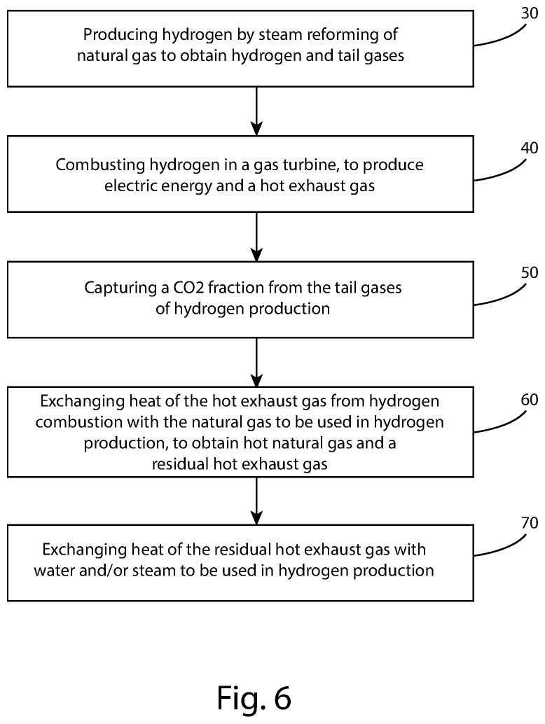

FIG. 6 illustrates a flow chart of a method for carbon neutral power generation, according to a first embodiment. The method comprises the following steps:
producing (30) hydrogen by steam reforming of natural gas from a natural gas pipeline to obtain hydrogen and tail gases; the step being preferably comprised of reacting hot natural gas together with hot compressed steam on a catalyst, by providing heat, to obtain a first gas mixture comprising hydrogen and carbon monoxide, followed by water gas shifting and hydrogen pressure swing adsorbing;
combusting (40) hydrogen from the hydrogen production step (30) together with air in a gas turbine coupled with an electric generator, to produce electric energy and an exhaust gas;
capturing (50) a CO₂ fraction from the tail gases from said hydrogen production step, to obtain CO₂ free tail gases;
exchanging (60) heat of the hot exhaust gas from the hydrogen combustion step with the natural gas to be used in said hydrogen production step by steam reforming, to obtain hot natural gas and a residual hot exhaust gas;
exchanging (70) heat of the residual hot exhaust gas from the preceding step with water and/or steam to be used in said hydrogen production step by steam reforming, to obtain hot compressed steam and a residual exhaust gas.

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

1. A method for carbon neutral power generation, the method comprising the following steps:
producing hydrogen by steam reforming of natural gas from a natural gas pipeline to obtain hydrogen and tail gases;
combusting hydrogen from the hydrogen production step together with air in a gas turbine coupled with an electric generator, to produce electric energy and a hot hydrogen combustion exhaust gas;
capturing a CO₂ fraction from the tail gases from said hydrogen production step, to obtain CO₂ free tail gases;
exchanging heat of the hot exhaust gas from the hydrogen combustion step with the natural gas to be used in said hydrogen production step by steam reforming, to obtain hot natural gas and a residual hot exhaust gas; and,
exchanging heat of the residual hot exhaust gas from the preceding step with water and/or steam to be used in said hydrogen production step by steam reforming, to obtain hot compressed steam and a residual exhaust gas.

2. The method of claim 1, comprising a step of providing heat to said hydrogen production step by combusting the CO₂ free tail gases, from the CO₂ fraction capturing step, together with air, with production of flue gases.

3. The method of claim 2, comprising a step of compressing and recirculating the flue gases from the step of combusting the CO₂ free tail gases to said step of hydrogen production.

4. The method of claim 2, comprising a step of capturing a CO₂ fraction from the flue gases from the step of combusting the CO₂ free tail gases.

5. The method of claim 1, comprising, before the hydrogen production step, the steps of:
withdrawing natural gas from a natural gas pipeline; reducing the pressure of the natural gas down to 8-10 bar; heating the natural gas, to obtain hot natural gas; and,
feeding the hot natural gas to the step of hydrogen production.

6. The method of claim 1, comprising the step of compressing the hydrogen from the hydrogen production step before feeding it to the hydrogen combustion step.

7. The method of claim 3, comprising a step of exchanging heat of the flue gases from the step of combusting the CO₂ free tail gases with water before the step of exchanging heat with the residual hot exhaust gas.

8. The method of claim 1, comprising a step of exchanging heat of the residual exhaust gas with a working fluid in a thermodynamic cycle, such as an organic Rankine cycle, a steam Rankine cycle or a CO₂ cycle.

9. A system for carbon neutral power generation comprising:
a natural gas feed line, connected to a natural gas pipeline;
a steam feed line;
a hydrogen production unit by steam reforming of natural gas to obtain hydrogen and tail gases stream, the hydrogen production unit being connected upstream to the natural gas feed line and the steam feed line, the hydrogen production unit being connected downstream to a hydrogen stream line and a tail gases stream line;
a gas turbine connected upstream to the hydrogen stream line, the gas turbine being configured to combust hydrogen together with air from an air feed line to obtain an exhaust gas, the gas turbine being coupled with an electric generator to produce electric energy;
a first heat exchanger, with a first inlet connected to an exhaust gas outlet of said gas turbine through a gas turbine exhaust line and a second inlet connected to said natural gas feed line, the first heat exchanger being configured to heat the feed of natural gas upstream the hydrogen production unit by steam reforming of natural gas by exchanging heat with the exhaust gas from the gas turbine;
a second heat exchanger, with a first inlet connected to an exhaust gas outlet of said first heat exchanger through a first heat exchanger exhaust line and a second inlet connected to a steam feed line, the second heat exchanger being configured to heat a stream of water or steam flowing inside said steam feed line upstream the hydrogen production unit by exchanging heat with the exhaust gas from the gas turbine downstream the first heat exchanger to obtain a stream of hot compressed steam;
a first carbon capture unit connected upstream to the tail gases stream line.

10. The system of claim 9, comprising a furnace connected upstream to a CO₂ free tail gases outlet of the first carbon capture unit and to an air inlet through a furnace feed line and configured to combust the CO₂ free tail gases together with air to produce heat to be provided to said hydrogen production unit and flue gases.

11. The system of claim 10, comprising a compressor connected upstream to an exhaust gas outlet of the furnace through an exhaust gas stream line and connected downstream to the hydrogen production unit through a compressor outlet line.

12. The system of claim 10, comprising a second carbon capture unit connected upstream to a flue gases outlet of the furnace through a second carbon capture unit feed line, the second carbon capture unit being configured to obtain CO₂ free flue gases.

13. The system of an 2, wherein, upstream the first heat exchanger, a gas turbine is arranged along a natural gas feed line, the gas turbine being configured to generate power by reducing the pressure of the natural gas down to 8-10 bar.

14. The system of claim 9, comprising a compressor connected upstream to a hydrogen outlet of said hydrogen production unit through a hydrogen outlet stream line, and connected downstream to said gas turbine through the hydrogen feed stream line.

15. The system of claim 10, comprising a heat exchanger connected upstream to an exhaust gas outlet of the furnace through an exhaust gas stream line and with a water inlet through a water inlet stream line and configured to heat water upstream the second heat exchanger.

16. The system of an, comprising a thermodynamic system connected upstream to a flue gas outlet of the second heat exchanger and configured to exchange residual heat of the flue gas with a working fluid in a thermodynamic cycle, such as an organic Rankine cycle, a steam Rankine cycle or a CO₂ cycle.

17. The system of 9, wherein the hydrogen production unit comprises the following sub-units:
a steam reformer, configured to react hot natural gas from the natural gas feed line together with hot compressed steam from the steam feed line on a catalyst, by providing heat, to obtain a first gas mixture of hydrogen and carbon monoxide together with residual natural gas and steam;
a water gas shift reactor, connected upstream to the steam reformer and configured to react carbon monoxide and steam of the first gas mixture from the steam reformer to obtain heat and a second gas mixture with a higher concentration of hydrogen together with carbon dioxide and residual natural gas, steam and carbon monoxide;
a hydrogen pressure swing adsorbing unit, connected upstream to the water gas shift reactor and configured to separate hydrogen from the remaining components of the second gas mixture from the water gas shift reactor, by adsorbing the remaining components of the second gas mixture on an adsorbent material, and periodically desorbing the adsorbed components by dropping the pressure to produce tail gases; and comprising a heat exchanger configured to exchange heat of the second gas mixture from the water gas shifting reactor with water to obtain steam to be used in the first carbon capture unit and/or in the second carbon capture unit.

18. The system of claim 17, comprising a heat exchanger connected upstream to a first gas mixture stream line and to a first syngas stream line configured to heat the first gas mixture stream, comprising CO₂ free tail gases and air, upstream the furnace, by exchanging heat with the first syngas from the steam reformer.

19. The system of claim 17, comprising a heat exchanger configured to transfer heat from the water gas shift reactor to a water stream and generate high temperature steam to feed an additional steam turbine configured to produce power.
